(19) United States
(12) Patent Application Publication
(10) Pub. No.: US 2007/0033278 A1
(43) Pub. Date: Feb. 8, 2007

(54) Method and apparatus for providing a list-based service

(76) Inventors: Sean S. Kelley, Barrington, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/199,547

(22) Filed: Aug. 8, 2005

(51) Int. Cl. G06F 15/173

(52) U.S. Cl. 709/224

(57) ABSTRACT

Various embodiments are described for providing a list-based service. One group of embodiments involves receiving a subscription to a list to which multiple list members are associated and then providing a notification when an aggregated state of the list satisfies a condition. The aggregated state of the list is based on at least a portion of the state information that pertains to each of the list members. Another group of embodiments involves sending (603) a subscription to a list to which multiple list members are associated and then receiving (605) a notification when an aggregated state of the list satisfies a condition. List-based services, such as presence, can benefit from notifications that are based on a list's aggregated state satisfying some condition.

### FIELD OF THE INVENTION

The present invention relates generally to communications and, in particular, to providing a list-based service.

### BACKGROUND OF THE INVENTION

List-based services, such as presence, currently allow a client or watcher to subscribe to a list of other users (a so-called “presence list”). The Open Mobile Alliance (OMA) is developing an architectural model for presence, such as architectural model 10 that is depicted in FIG. 1. (A more detailed description of architectural model 10 can be found in OMA document OMA-AD-Presence_SIMPLE-V1_{—}0-20050415-C, “Presence SIMPLE Architecture Document.”) Architectural model 10 includes a Resource List Server (RLS), which serves as the functional entity that accepts and manages subscriptions to presence lists. After accepting a subscription, an RLS notifies the subscribed client/watcher when the presence state of a list member changes. The watcher may also indicate what presence state attributes or elements (e.g., location and availability) for each list member are of particular interest and/or when the watcher should be notified regarding each member (e.g., when a list member's location or availability changes).

List-based services, such as presence, are relatively popular among users. Thus, enhancements that expand the capability of these services as they are defined today would likely be desirable in the marketplace.

### BRIEF DESCRIPTION OF THE DRAWINGS

FIG. 1 depicts a prior-art architectural model for providing presence services.

FIG. 2 is a block diagram depiction of a wireless communication system in accordance with multiple embodiments of the present invention.

FIG. 3 is a more generalized block diagram depiction of a wireless communication system in accordance with multiple embodiments of the present invention.

FIG. 4 is a messaging flow diagram depicting communication between a client and a Resource List Server (RLS) in accordance with certain embodiments of the present invention as compared to some illustrative prior art messaging.

FIG. 5 is a logic flow diagram of functionality performed by fixed network equipment (FNE) in accordance with multiple embodiments of the present invention.

FIG. 6 is a logic flow diagram of functionality performed by a remote unit in accordance with multiple embodiments of the present invention.

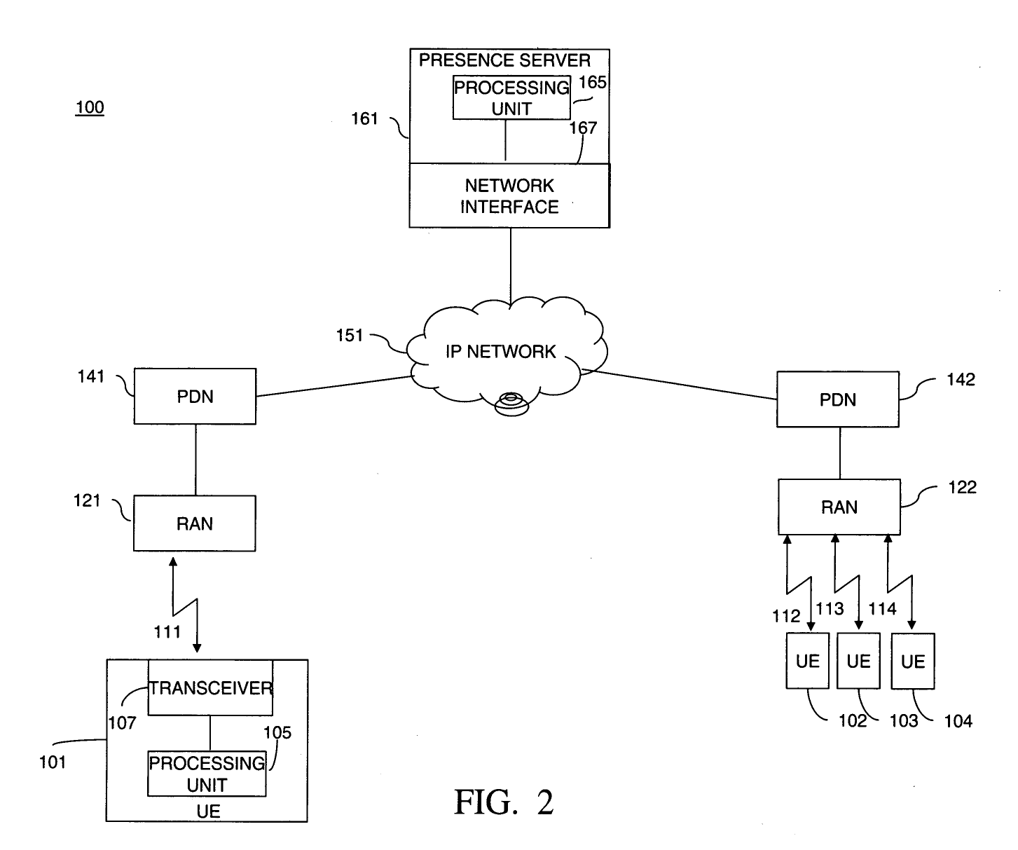

Specific embodiments of the present invention are disclosed below with reference to FIGS. 2-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described for providing a list-based service. One group of embodiments involves receiving a subscription to a list to which multiple list members are associated and then providing a notification when an aggregated state of the list satisfies a condition. The aggregated state of the list is based on at least a portion of the state information that pertains to each of the list members. Another group of embodiments involves sending a subscription to a list to which multiple list members are associated and then receiving a notification when an aggregated state of the list satisfies a condition. List-based services, such as presence, can benefit from notifications that are based on a list's aggregated state satisfying some condition.

The disclosed embodiments can be more fully understood with reference to FIGS. 2-6. FIG. 2 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for wireless telecommunications systems. (These groups may be contacted via http://www.openmobilealliance.com, http://www.3gpp.org/, http://www.3gpp2.com/ and http://www.ieee802.org/, respectively.) Communication system 100 represents a system having an architecture in accordance with one or more of the 3GPP2 technologies (e.g., CDMA 2000 and/or HRPD (also known as 1xEV-DO or IS-856)), suitably modified to implement the present invention. For example, RANs 121 and 122 may each employ the same wireless technology or different wireless technologies.

Alternative embodiments of the present invention may be implemented in communication systems that employ other or additional technologies such as, but not limited to, those described in the 3GPP specifications (e.g., GSM, GPRS, EDGE, W-CDMA, UTRAN, FOMA, UMTS, HSDPA, and HSUPA), those described in the IEEE's 802.11, 802.16, and 802.20 specifications, those described in the OMA standards specifications, those described in the IS-136 (TDMA Third Generation Wireless Standards) specification, those described in the IS-95 (CDMA) specification, 1xEV-DV technologies, and integrated dispatch enhanced network technologies. Furthermore, alternative embodiments of the present invention may also be implemented in communication systems in which RANs 121 and 122 represent access networks that physically and/or functionally overlap considerably. For example, RANs 121 and 122 may differ only in the component access points (APs), base transceiver stations (BTSs), or base station sectors that communicate with a particular remote unit.

More specifically, communication system 100 comprises user equipment (UE) 101-104, radio access networks (RANs) 121 and 122, packet data networks 141 and 142, IP (internet protocol) network 151, and presence server 161. Those skilled in the art will recognize that FIG. 2 does not depict all of the network equipment necessary for system 100 to operate but only those system components and logical entities particularly relevant to the description of embodiments herein. For example, packet data networks are known to comprise devices such as packet data serving nodes (PDSNs). Also, RANs are known to comprise devices such as base transceiver stations (BTSs), base site controllers (BSCs), and packet control functions (PCFs). Alternatively, RANs are known to comprise one or more devices such as WLAN (wireless local area network) stations (which include access points (APs), AP controllers/switches, and/or WLAN switches), packet control units (PCUs), and/or radio network controllers (RNCs). However, none of these devices are specifically shown in FIG. 2.

Presence server 161 is depicted in FIG. 2 as comprising processing unit 165 and network interface 167. In general, components such as processing units and network interfaces are well-known. For example, server processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, and/or a protocol specification, those skilled in the art are aware of the many design and development techniques available to implement a server processing unit that performs the given logic. Therefore, presence server 161 represents a known presence server that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, the presence server aspect of the present invention may be implemented in a RAN, in a PDN, on a dedicated network server platform, or distributed such components.

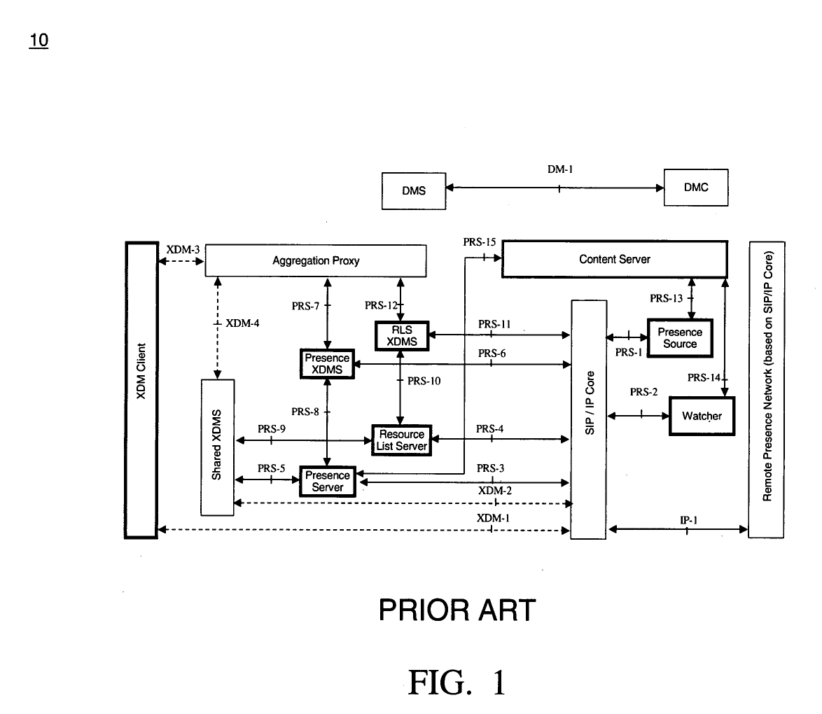

In certain embodiments, presence server 161 may embody aspects of architectural model 10 depicted in FIG. 1. For example, presence server 161 (i.e., its processing unit 165 and network interface 167) may embody the following elements of architectural model 10 (and their interfaces), as described in OMA document OMA-AD-Presence_SIMPLE-V1_{—}0-20050415-C: the Presence Server (per the OMA document and thus to be distinguished from “presence server” used throughout the present description), the Resource List Server, the Presence XDMS, and the RLS XDMS. Of course in other embodiments, presence server 161 may embody another grouping of architectural model 10 elements or embody an altogether different functional architecture. Whatever the case, presence server 161 represents a known presence server, perhaps employing a known functional architecture, that has been adapted (functionally and/or architecturally), in accordance with the description herein, to implement multiple embodiments of the present invention.

RANs 121 and 122 use air interfaces comprising channel groups 111-114 for communication with UEs 101-104. 3GPP2 channel groups 111-114 each comprise traffic channels, which are dynamically assigned and de-assigned to support user services, and a variety of well-known non-traffic channel types, such as broadcast channels, paging channels, access channels and common control channels, all in accordance with the particular 3GPP2 signaling technology used.

Remote units, or UEs, may be thought of as mobile stations (MSs); however, UEs are not necessarily mobile nor able to move. Also, remote units/UEs may be wireless devices but they do not necessarily need to be wireless; a remote unit/UE may be either wired or wireless. Moreover, remote unit/UE platforms are known to refer to a wide variety of consumer electronic platforms such as, but not limited to, mobile stations (MSs), access terminals (ATs), terminal equipment, gaming devices, personal computers, personal digital assistants (PDAs), cable set-top boxes and satellite set-top boxes. In particular, UE 101 comprises processing unit 105, transceiver 107, a keypad (not shown), a speaker (not shown), a microphone (not shown), and a display (not shown). Processing units, transceivers, keypads, speakers, microphones, and displays as used in UEs are all well-known in the art.

For example, UE processing units are known to comprise basic components such as, but neither limited to nor necessarily requiring, microprocessors, digital signal processors (DSPs), microcontrollers, memory devices, application-specific integrated circuits (ASICs), and/or logic circuitry. Such MS components are typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic. Therefore, UE 101 represents a known UE that has been adapted, in accordance with the description herein, to implement embodiments of the present invention.

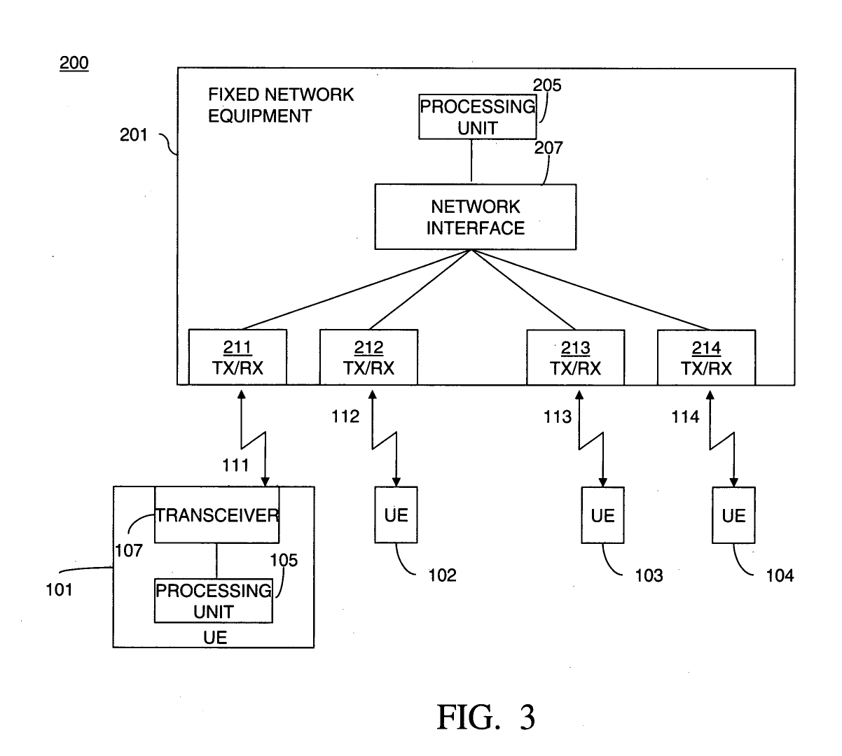

FIG. 3 is a block diagram depiction of a wireless communication system 200 in accordance with multiple embodiments of the present invention. Communication system 200 is depicted in a more generalized manner than communication 100. In particular, the communications infrastructure is represented by fixed network equipment (FNE) 201. Those skilled in the art will recognize that FIG. 2 does not depict all of the physical FNE components necessary for system 200 to operate but only those system components and logical entities particularly relevant to the description of embodiments herein. For example, FIG. 2 depicts FNE 201 as comprising transceivers 211-214, network interface 207, and processing unit 205. The description above regarding network interface 167 and processing unit 165 applies respectively to network interface 207 and processing unit 205 except that neither network interface 207 nor processing unit 205 are depicted as components of a presence server. Thus, network interface 207 and processing unit 205 may be implemented in and across various physical components of FNE 201, these physical components perhaps functioning in non-presence-server capacities also, or simply implemented on a single platform, which may additionally function in a non-presence-server capacity.

Operation of various embodiments in accordance with the present invention occur substantially as follows. Relevant operation of embodiments illustrated by FIG. 3 begins with UE processing unit 105 sending, via transceiver 107, a subscription to a list. For purposes of illustration, UEs 102-104 will represent list members that are associated with this list. However, list members need not be UEs. For example, all manner of user devices and/or logical groupings of devices could, in addition or instead of, be list members. FNE processing unit 205 then receives the subscription to the list via network interface 207. The information that is actually sent to communicate the subscription to the list may indicate the list in many different ways. For example, the information may identify (in a manner discernable by FNE processing unit 205, but not necessarily by anyone/anything else) the identity of an already defined list or the identity of list members that are to makeup the list.

Furthermore, the subscription to the list may involve sending a single subscription message or multiple messages, and the subscription may take the form of a subscription (or multiple subscriptions) to a number of sublists. These sublists may not be otherwise related to one another or organized in a list-sublist fashion, rather they are merely referred to as “sublists” and together as a “list” for simplicity of description. For example, the “sublists” may otherwise simply be a group of independent lists.

In some embodiments, in response to receiving the subscription to the list, FNE processing unit 205, via network interface 207, subscribes to each list member. In these embodiments, this is how FNE processing unit 205 is able to receive updates as the state information of individual list members changes. Moreover, due to privacy safeguards that may be implemented in particular embodiments, FNE processing unit 205 may be able to subscribe to information about list members that UE 101 is not authorized to subscribe to.

Depending on the embodiment, the subscription to the list may also include an indication of a condition that FNE processing unit 205 would use in establishing a condition to test an aggregated state of the list. The information that is actually sent to communicate the condition may indicate the condition in many different ways. For example, the information may identify (in a manner discernable by FNE processing unit 205, but not necessarily by anyone/anything else) the identity of an already defined condition or the identity of component parts of a condition. For example, one of the many different ways to indicate the condition would be to indicate what state attributes are relevant to the condition and when the condition is satisfied (i.e., what values/range of values will cause the condition to be satisfied).

In different embodiments, the condition need not be indicated in the subscription to the list, but rather associated with the list itself is a policy that indicates the condition (or perhaps the policy is not so much a policy but simply the indication of the condition itself). In other words, the condition may be an intrinsic characteristic of the list itself (i.e., the condition may be stored in the network and associated with the list). The inclusion of the condition in a policy, while not necessary, can provide added functionality. For example, the policy may be based on authorization levels. “Authorized” clients are allowed to see the state of each list member, while the policy applies to “unauthorized” clients who are only provided aggregated state information when the condition is satisfied. Such a policy could be used to give greater privacy to list members.

However the condition to be used is made known to FNE processing unit 205, processing unit 205 uses the condition to test an aggregated state of the list. The aggregated state of the list is based on at least a portion of the state information that pertains to each list member. For state information that has multiple attributes, the aggregated state of the list involves aggregating one or more state attributes from the state information of each list member.

In some embodiments, the list is a presence list and the state information is presence state information; however, the list and state information need not be limited to presence. In the case of presence, the presence state information may refer to the state of or information pertaining to any of a list member's presence attributes (e.g., availability, mood, location, etc.). The aggregated presence state of the list would involve one or more presence attributes. For the case in which aggregated presence state of the list focuses on the availability attribute of each list member, the aggregated presence state at a particular time might be 10% availability (i.e., 10% of the list members are available). Thus, the availability attribute of each list member is aggregated to arrive at a percent-of-members-available state for the list as a whole. Moreover, as discussed above, the subscription to the list may actually involve subscribing to multiple lists, or sublists. In such cases, determining the aggregated state would involve aggregating across multiple lists.

Having determined the aggregated state of the list, processsing unit 205 uses the condition to test it. The particular condition used can take many different forms. For example, the condition may be satisfied whenever the aggregated state changes at all or does not change during a period of time. Alternatively, the condition may only be satisfied when the aggregated state changes (or non-changes) meet additional requirements. Some of these additional requirements might include the following:

a threshold portion of the list members have a presence attribute of a particular value (e.g., 50% of the list members are available),

a threshold portion of the list members have presence attributes of particular values (e.g., 50% of the list members are available and their mood is happy),

a threshold portion of the list members have a presence attribute in a particular range of values (e.g., one of the list members is located within 5 miles of the office, 50% of the list members will stop being available within 10 minutes, or 50% of the list members will leave the office within 10 minutes (these last two examples are based on a list member's future presence/presence itinerary attribute),

a first threshold portion of the list members have a first presence attribute of a first value and a second threshold portion of the list members have a second presence attribute of a second value,

a first threshold portion of the list members have a first presence attribute in a first range of values and a second threshold portion of the list members have a second presence attribute in a second range of values,

a threshold portion of the of list members have presence attributes in particular value ranges (e.g., 50% of the list members are not busy and located within 5 miles of the office),

the aggregated presence state has changed by a threshold amount (e.g., 20% more of the list members are now available) or not changed by a threshold amount during a period of time,

the aggregated presence state has changed at a threshold rate (e.g., more than 50% of the list members have become unavailable in the last 10 minutes) or not changed at a threshold rate during a period of time, and/or a threshold portion of a first sublist of list members have a presence attribute in a first range of values and a threshold portion of a second sublist of list members have a presence attribute in a second range of values. The last example listed could apply to a store manager, for example. The manager may want to be informed if there are customers but no sales clerks available. In this example, the list would include all of the people within the store, the first subgroup would be the customers, and the second subgroup would be the sales clerks. Clearly, the set of possible conditions that could be used to test the aggregated state of the list is exceedingly large and far too numerous to document in detail herein.

When the aggregated state of the list satisfies the condition, FNE processing unit 205 provides a notification, via network interface 207, to UE 101. Depending on the embodiment, the notification (or associated messaging) may convey information based on the aggregated state. For example, the aggregated state itself may be conveyed (e.g., 5 list members available, 3 unavailable) or information in some derived form of the aggregated state. The specific state information for each list member may also, or alternatively, be conveyed. Thus, UE processing unit 105 receives the notification (and any associated messaging) via transceiver 107.

In response to the notification, UE processing unit 105 may send a request to initiate a communication session (such as a push-to-talk call) via transceiver 107. In some embodiments, this may be accomplished through SIP (Session Initiation Protocol) INVITE messaging. The request may also indicate a manner for determining a target list of invitees. There are many ways that UE 101 might indicate for determining the target list of invitees. Some, but not all, examples will be provided due to the number of possibilities. For example, UE 101 might indicate that the target list of invitees be determined simply using list members indicated by the request itself (e.g., invite the members identified in the request), be determined by using all the list members (e.g., invite all the members of the list), be determined by using list members whose presence state contributes to the aggregated presence state of the list satisfying the condition (e.g., invite all the members of the list whose individual presence state is in accordance with the condition), be determined by using list members whose presence state includes a presence attribute of a particular value, be determined by using list members whose presence state includes a presence attribute in a particular range of values, or be determined by using a proportional number of list members from a first subgroup of the plurality of list members as are used from a second subgroup of the plurality of list members (e.g., invite an equal number of men and women or invite 5 students for every teacher). FNE 201 receives the request to initiate the communication session and invites a target list determined in accordance with any indications from UE 101.

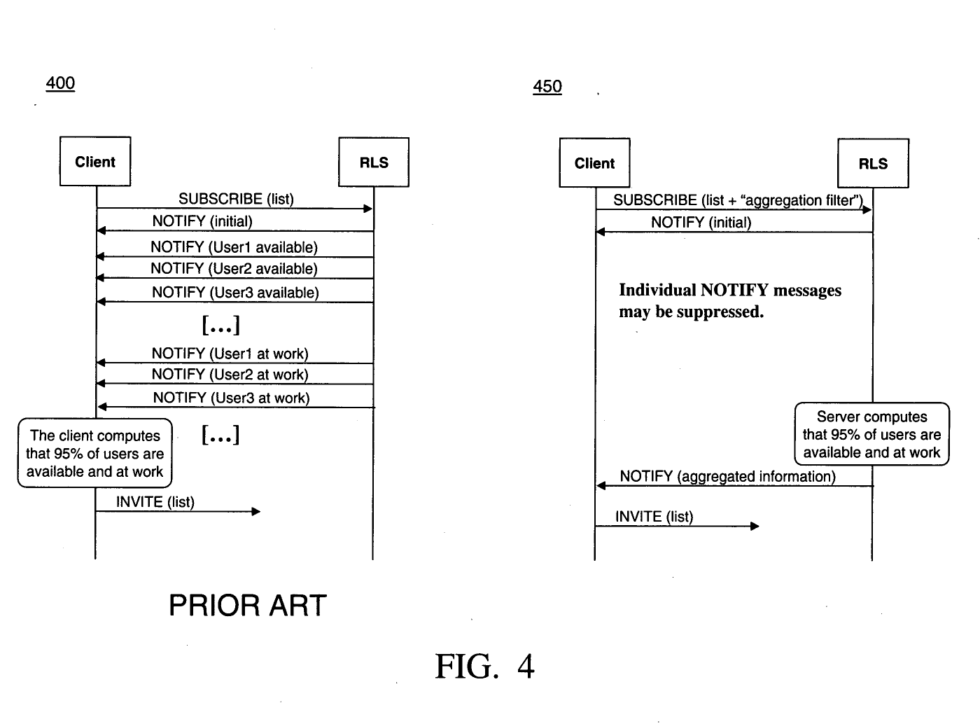

FIG. 4 is a messaging flow diagram depicting communication between a client and a Resource List Server (RLS) in accordance with certain embodiments of the present invention as compared to some illustrative prior art messaging. Messaging flow diagram 400 illustrates prior art messaging such as that which could occur between a client and an RLS in a system that incorporates some or all of the aspects of architectural model 10 depicted in FIG. 1. In diagram 400, the client subscribes to a list using the RLS and the RLS then notifies the client whenever a list member's presence attributes (e.g., availability and location) change. The client then may determine from the notifications how many list members are available and at work.

Messaging flow diagram 450 depicts illustrative messaging such as that which could occur between a client and an RLS in a system that incorporates some or all of the aspects of architectural model 10 as well certain aspects of embodiments described herein. In diagram 450, the client subscribes to a list and also indicates a condition (sometimes referred to as an “aggregation filter”) to the RLS. Depending on the embodiment, the subscription may also include an indication that presence state changes for individual members of the list should be suppressed or rather than indicating such suppression in the subscription it may simply be considered default operation. When included in the subscription, this indication may be no more than the indication of an aggregation filter itself or even simply the RLS' knowledge of the authorization level of the subscribing client itself. If the subscribing client is not authorized to access the individual presence states of list members, the presence state changes for individual members of the list would be suppressed. Furthermore, either the condition or the policy associated with a list may need to incorporate some sort of permissions filter, for subscribers with relatively low authorization, which would limit even the communication of aggregated state information unless, for example, there are a minimum number of members within the list. This permission filter may be specific to the particular aggregated presence condition/policy being used. In contrast to diagram 400, the RLS in diagram 450 notifies the client when the aggregated state of the list satisfies the condition.

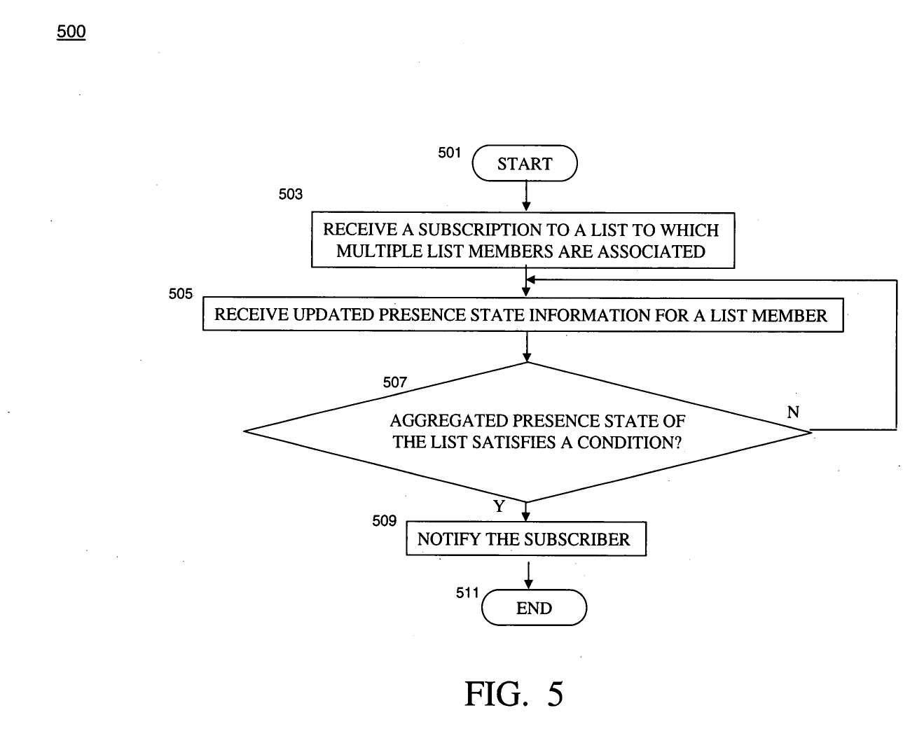

FIG. 5 is a logic flow diagram of functionality performed by fixed network equipment (FNE) in accordance with multiple embodiments of the present invention. Logic flow 500 begins (501) when the FNE receives (503) a subscription to a list to which multiple list members are associated. In the embodiments depicted, the FNE receives (505) updated presence state information for a list member; however, in alternative embodiments or instances in which the aggregated state may change without a list member's state changing (e.g., time-based condition) the receipt of updated state information is not required. When (507) the aggregated state of the list satisfies a condition, the FNE notifies (509) the subscribing device, and logic flow 500 ends (511). Although, flow 500 has been described in terms of the FNE/server performing various operations, one of skill in the art will appreciate that a non-server or a non-FNE device (e.g., one or more UEs (wireless or wired)) could instead perform these operations.

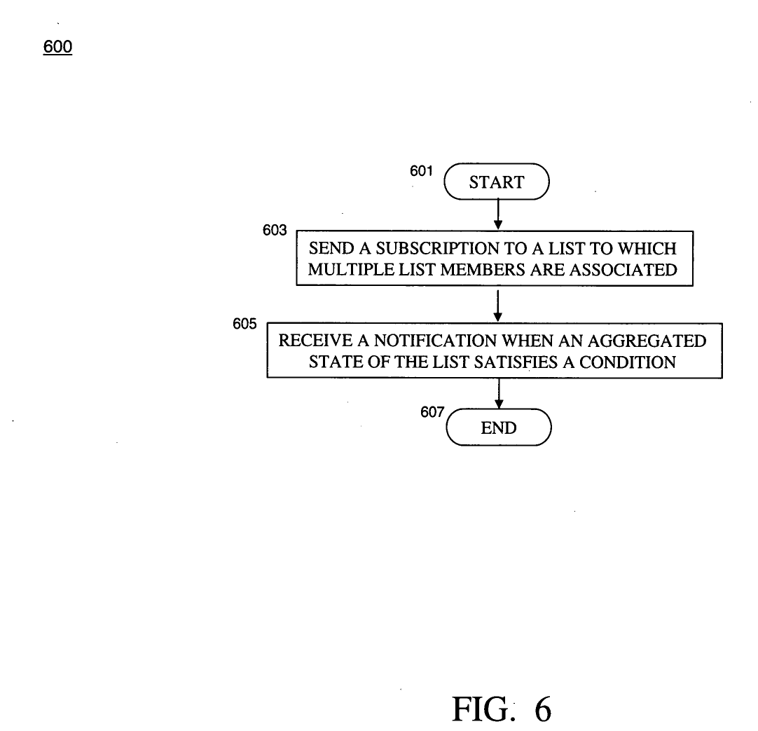

FIG. 6 is a logic flow diagram of functionality performed by a remote unit (whether wireless or wired) in accordance with multiple embodiments of the present invention. Logic flow 600 begins (601) when the remote unit sends (603) a subscription to a list to which multiple members are associated. The remote unit then receives (605) a notification when an aggregated state of the list satisfies a condition, the aggregated state of the list being based on at least a portion of the state information that pertains to each of the plurality of list members. Logic flow 600 then ends (607). Although, flow 600 has been described in terms of the remote unit performing various operations, one of skill in the art will appreciate that a server or an FNE device could instead perform these operations.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for providing a service comprising:
receiving a subscription to a list to which a plurality of list members are associated;
providing a notification when an aggregated state of the list satisfies a condition, wherein the aggregated state of the list is based on at least a portion of the state information that pertains to each of the plurality of list members.

2. The method of claim 1,
wherein receiving the subscription further comprises receiving at a server the subscription to the list transmitted by a client and
wherein providing the notification further comprises providing the notification to the client by the server.

3. The method of claim 1, wherein the subscription to the list comprises an indication of the condition.

4. The method of claim 1, wherein the list is associated with a policy that indicates the condition.

5. The method of claim 1, wherein the subscription to the list comprises at least one subscription to a plurality of sublists.

6. The method of claim 1,
wherein the aggregated state of the list comprises an aggregated presence state of the list and
wherein the state information comprises presence state information.

7. The method of claim 6, wherein the condition comprises at least one characteristic from the group consisting of
the aggregated presence state has changed,
the aggregated presence state has changed by a threshold amount,
the aggregated presence state has changed at a threshold rate,
the aggregated presence state has not changed during a period of time,
the aggregated presence state has not changed by a threshold amount during a period of time,
the aggregated presence state has not changed at a threshold rate during a period of time,
a threshold portion of the plurality of list members have a presence attribute of a particular value,
a threshold portion of the plurality of list members have presence attributes of particular values,
a threshold portion of the plurality of list members have a presence attribute in a particular range of values,
a threshold portion of the plurality of list members have presence attributes in particular value ranges,
a first threshold portion of the plurality of list members have a first presence attribute of a first value and a second threshold portion of the plurality of list members have a second presence attribute of a second value,
a first threshold portion of the plurality of list members have a first presence attribute in a first range of values and a second threshold portion of the plurality of list members have a second presence attribute in a second range of values, and
a threshold portion of a first sublist of the plurality of list members have a presence attribute in a first range of values and a threshold portion of a second sublist of the plurality of list members have a presence attribute in a second range of values.

8. The method of claim 6, wherein notifying the client comprises conveying information based on the aggregated presence state.

9. The method of claim 6, further comprising
receiving a request to initiate a communication session;
inviting to the communication session a target list, wherein the target list is a list from the group consisting of
list members indicated in the request to initiate the communication session,
the plurality of list members,
list members from the plurality of list members whose presence state contributes to the aggregated presence state of the list satisfying the condition,
list members from the plurality of list members whose presence state includes a presence attribute of a particular value,
list members from the plurality of list members whose presence state includes a presence attribute in a particular range of values, and
a second subgroup of the plurality of list members and a proportional number of list members from a first subgroup of the plurality of list members.

10. A method for providing a service comprising:
sending a subscription to a list to which a plurality of list members are associated;
receiving a notification when an aggregated state of the list satisfies a condition, wherein the aggregated state of the list is based on at least a portion of the state information that pertains to each of the plurality of list members.

11. The method of claim 10,
wherein sending the subscription further comprises sending, by a client to a server, the subscription to the list and
wherein receiving the notification further comprises receiving by the client the notification.

12. The method of claim 10, wherein the subscription to the list comprises an indication of the condition.

13. The method of claim 10, wherein the list is associated with a policy that indicates the condition.

14. The method of claim 10, wherein the subscription to the list comprises at least one subscription to a plurality of sublists.

15. The method of claim 10,
wherein the aggregated state of the list comprises an aggregated presence state of the list and
wherein the state information comprises presence state information.

16. The method of claim 15, wherein the condition comprises at least one characteristic from the group consisting of
the aggregated presence state has changed,
the aggregated presence state has changed by a threshold amount,
the aggregated presence state has changed at a threshold rate,
the aggregated presence state has not changed during a period of time,
the aggregated presence state has not changed by a threshold amount during a period of time,
the aggregated presence state has not changed at a threshold rate during a period of time,
a threshold portion of the plurality of list members have a presence attribute of a particular value,
a threshold portion of the plurality of list members have presence attributes of particular values,
a threshold portion of the plurality of list members have a presence attribute in a particular range of values,
a threshold portion of the plurality of list members have presence attributes in particular value ranges,
a first threshold portion of the plurality of list members have a first presence attribute of a first value and a second threshold portion of the plurality of list members have a second presence attribute of a second value,
a first threshold portion of the plurality of list members have a first presence attribute in a first range of values and a second threshold portion of the plurality of list members have a second presence attribute in a second range of values, and
a threshold portion of a first sublist of the plurality of list members have a presence attribute in a first range of values and a threshold portion of a second sublist of the plurality of list members have a presence attribute in a second range of values.

17. The method of claim 15, wherein receiving a notification comprises receiving information based on the aggregated presence state.

18. The method of claim 15, further comprising
sending a request to initiate a communication session, wherein the request comprises an indication of a manner for determining a target list of invitees, and wherein the manner indicated comprises a manner from the group consisting of
using list members indicated by the request,
using the plurality of list members,
using list members from the plurality of list members whose presence state contributes to the aggregated presence state of the list satisfying the condition,
using list members from the plurality of list members whose presence state includes a presence attribute of a particular value,
using list members from the plurality of list members whose presence state includes a presence attribute in a particular range of values, and
using a proportional number of list members from a first subgroup of the plurality of list members as are used from a second subgroup of the plurality of list members.

19. Fixed network equipment comprising:
a network interface;
a processing unit, communicatively coupled to the network interface,
adapted to receive, via the network interface, a subscription to a list to which a plurality of list members are associated;
adapted to provide a notification, via the network interface, when an aggregated state of the list satisfies a condition, wherein the aggregated state of the list is based on at least a portion of the state information that pertains to each of the plurality of list members.

20. A remote unit comprising:
a transceiver;
a processing unit, communicatively coupled to the transceiver,
adapted to send, via the transceiver, a subscription to a list to which a plurality of list members are associated;
adapted to receive a notification, via the transceiver, when an aggregated state of the list satisfies a condition, wherein the aggregated state of the list is based on at least a portion of the state information that pertains to each of the plurality of list members.

21. The remote unit of claim 20,
wherein the aggregated state of the list comprises an aggregated presence state of the list,
wherein the state information comprises presence state information,
and wherein the processing unit is further
adapted to send, via the transceiver, a request to initiate a communication session, wherein the request comprises an indication of a manner for determining a target list of invitees, and wherein the manner indicated comprises a manner from the group consisting of
using list members indicated by the request,
using the plurality of list members,
using list members from the plurality of list members whose presence state contributes to the aggregated presence state of the list satisfying the condition,
using list members from the plurality of list members whose presence state includes a presence attribute of a particular value,
using list members from the plurality of list members whose presence state includes a presence attribute in a particular range of values, and
using a proportional number of list members from a first subgroup of the plurality of list members as are used from a second subgroup of the plurality of list members.
